(19) United States
(12) Patent Application Publication
(10) Pub. No.: US 2009/0080293 A1
(43) Pub. Date: Mar. 26, 2009

(54) CLOCK HAVING AN ELECTROLUMINESCENT LIGHT (EL) FACE PLATE AND METHOD THEREFOR

(76) Inventor: Stephen A. Richman, Las Vegas, NV (US)

Correspondence Address: WEISS & MOY PC, 4204 NORTH BROWN AVENUE, SCOTTSDALE, AZ, 85251, US

(21) Appl. No.: 11/860,671

(22) Filed: Sep. 25, 2007

(51) Int. Cl. G04B 19/32

(52) U.S. Cl. 368/226

(57) ABSTRACT

An electroluminescent (EL) clock has a face plate. An EL light panel is coupled to a front surface of the face plate. The EL light panel has a multi-color/sectional design. A control circuit is coupled to the EL light panel and attached to a rear surface of the face plate. The control circuit is used to individually control the lighting of each color/section of the multi-color/sectional design. A pair of clock hands is rotatably coupled to the face plate. A clock control device is coupled to the pair of clock hands to rotate the pair of clock hands. A power supply is coupled to the control circuit and the cock control device.

### FIELD OF THE INVENTION

This invention relates to clocks and, more specifically, to a clock having an electroluminescent light face plate which allows for controlled lighting of a multi-color display on the face plate.

### BACKGROUND OF THE INVENTION

Clocks having clock faces with moving hands have been around for many years. These cloaks come in many different shapes, styles and colors. However, the basic features are always the same, namely a clock face plate having two hands which rotate around the face plate.

Attempts have been made to update these basic clock features. For example, logos of different sporting teams and/or colleges have been painted on clock face plates. Different scenic designs have also been painted on clock face plates. However, these types of paints are static pictures having no movement.

Another problem with current clocks having clock faces with moving hands is that at night the moving hands are difficult to see if the clock is situated in a room with little to no lighting. This is due to the fact that these types of clocks have no backlighting or illumination capability.

Therefore, a need existed to provide a device and method to overcome the above problem.

### SUMMARY OF THE INVENTION

In accordance with another embodiment of the present invention, an electroluminescent (EL) clock is disclosed. The EL clock has a face plate. An EL light panel is coupled to a front surface of the face plate. The EL light panel has a multi-color/sectional design. A control circuit is coupled to the EL light panel and attached to a rear surface of the face plate. The control circuit is used to individually control the lighting of each color/section of the multi-color/sectional design. A pair of clock hands is rotatably coupled to the face plate. A clock control device is coupled to the pair of clock hands to rotate the pair of clock hands. A power supply is coupled to the control circuit and the cock control device.

In accordance with another embodiment of the present invention, a method of forming an electroluminescent (EL) clock is disclosed. The method comprising: providing a face plate; attaching an electroluminescent (EL) light panel to a front surface of the face plate, the EL light panel having a multi-color/sectional design; attaching a control circuit to the EL light panel and to a rear surface of the face plate, the control circuit individually controlling the lighting of each color/section of the multi-color/sectional design; attaching a clock control device and a pair of clock hands to the face plate so the pair of clock hands rotate around the face plate; and attaching a power supply to the control circuit and the cock control device.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified functional block diagram of an Electroluminescent (EL) light used in a face plate of the EL clock of the present invention;

FIG. 2 is an front view of the EL clock of the present invention;

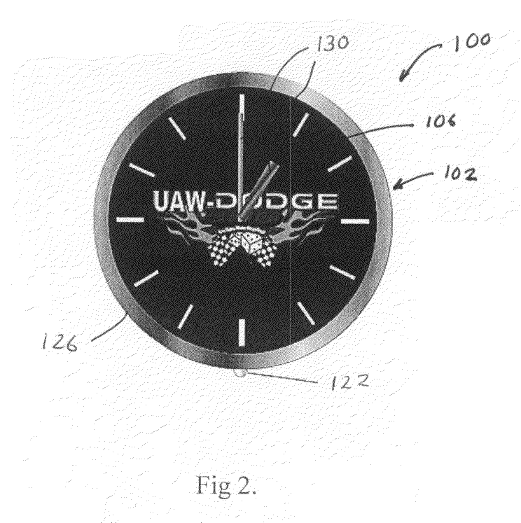

FIG. 3 is a back view of the EL clock of the present invention;

FIG. 4 is a side view of the EL clock of the present invention; and

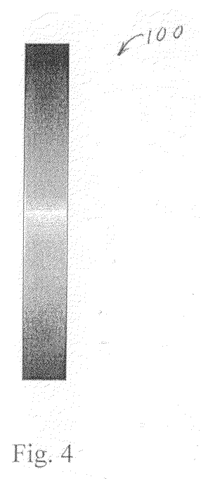

FIG. 5 is a simplified functional block diagram of the control circuit for the EL panel.

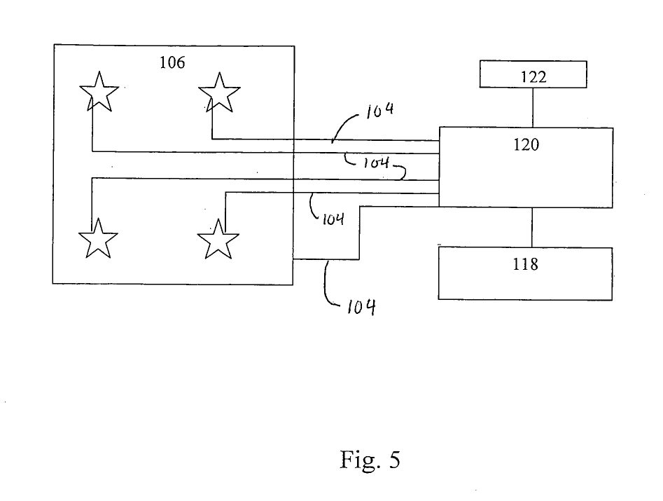

### DETAILED DESCRIPTION

With reference now to the Figures, an electroluminescent (EL) clock 100 (hereinafter EL clock 100) is shown. The EL clock 100 has a face plate 102. In the embodiment depicted in the Figures, the face plate 102 is circular in shape. However, this is just shown as an example. The face plate 102 may be formed in other geometric shapes without departing from the spirit and scope of the present invention.

The face plate 102 is formed of an EL display 106. The EL display 106 will have a multi-sectional and/or color design (hereinafter multi-color). In the embodiment shown in the Figures, the EL display 106 has a UAW-DODGE® text with graphics representing flames, dice, and a checkered flag. However, this is just shown as an example and should not be seen as to limit the scope of the present invention. The multi-color design can take on any form such as that of a college/professional sports team logo, cartoon character, holiday scene/character, corporate logos, tourist attractions, and the like. Again, the listing of the above is given as an example and should not be seen as to limit the scope of the present invention. Other types of multi-color designs may be used without departing from the spirit and scope of the present invention.

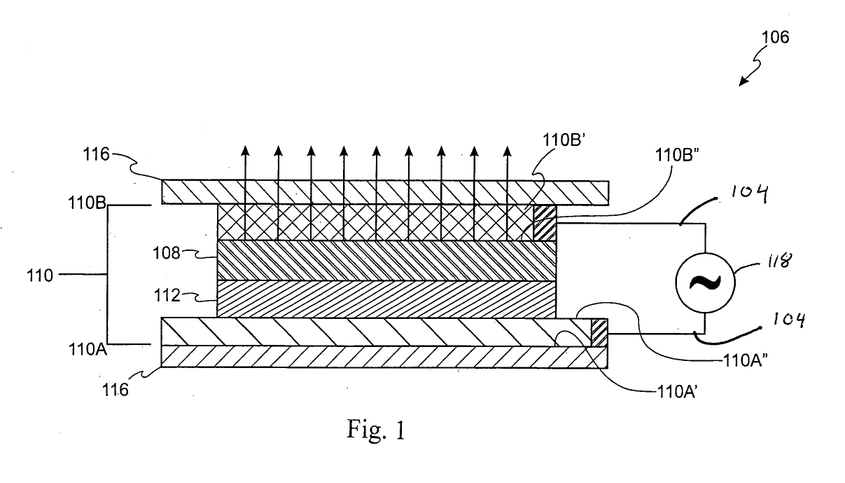

The EL display 106 is actually an EL lamp. The EL display 106 will emit light. However, unlike a traditional lamp, instead of creating light by heating a filament, the EL display 106 uses a phosphorescent material 108 which glow when exposed to a small electrical current. As shown in FIG. 1, the EL display 106 has a pair of electrodes 110. The pair of electrodes 110 generally comprises a bottom electrode 110A and a top electrode 110B. At least one of the electrodes 110A or 110B will be transparent to allow the escape of the produced light. As shown in FIG. 1, the top electrode 110B is transparent. In the embodiment of FIG. 1, the top electrode 110B uses a transparent Indium Tin Oxide (ITO) conductive ITO film. Glass coated with indium oxide or tin oxide is may also be used as the transparent electrode, the top electrode 10B. The bottom electrode 110A is generally comprised of an insulator, such as glass coated with a reflective metal.

A dielectric layer 112 is formed on top of the bottom electrode 110A. A phosphorescent material 114 is then disposed on the dielectric layer 112. The phosphorescent material 114 may be applied to form multi-color designs as described above. A protective film 116 may be placed on a surface 110B′ of the top electrode 110B opposite of the surface 11B″ coupled to the phosphorescent material 108. The protective film 116 may also be placed on a surface 110A′ of the bottom electrode 110A opposite of the surface 11B″ coupled to the dielectric layer 112. Conductors 104 are then coupled to the electrodes 110A or 110B. In general, the conductors 104 are copper or aluminum foil conductors. The conductors 104 are then coupled to a power supply 118. The phosphorescent material 108 will glow when exposed to a small electrical current from the power supply 118.

Different sets of conductors 104 are coupled to different colors/sections of the multi-color design. This will allow individual control of the lighting of the multi-color design. In accordance with on embodiment of the present invention, a controller 120 is coupled to each of the sets of conductors 116 and to the power supply 118. The controller 120 will control which colors/sections of the multi-color design will be illuminated. An activation device 122 may be coupled to the controller 120. The activation device 122 will allow one to activate or deactivate the illumination of the EL display 106. The activation device 122 may be a switch, a motion detector, sound detector, infrared detector, or the like. The listing of the above is given as an example and should not be seen as to limit the scope of the present invention.

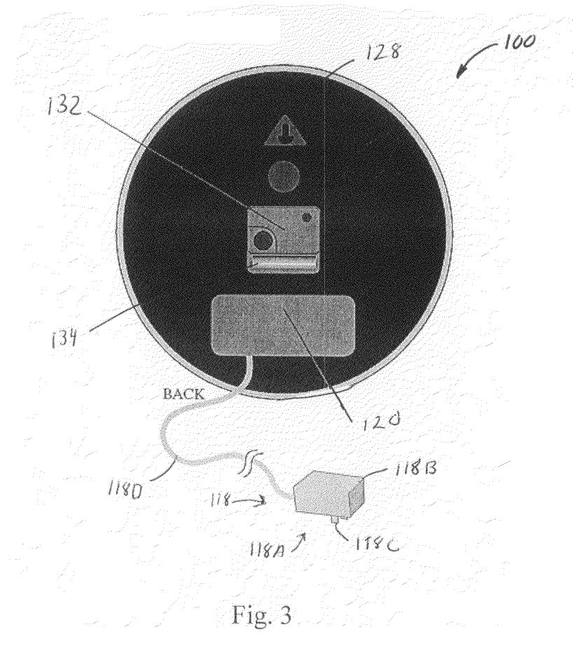

As shown more clearly in FIG. 3, the controller 120 is mounted to the back surface of the face plate 102. In this embodiment, the power supply 118 is an AC power supply 118A. The AC power supply 118A will generally have a regulator device 118B. The regulator device 118A will control the signal that is sent to the controller 120 and hence the EL display 102A. The regulator 118A will have a plug 118C that will fit into a standard wall outlet. A wire cord 118D is generally used to couple the regulator 118A to the EL display 106. Other sources of power may be used without departing from the spirit and scope of the present invention. For example, the power supply 118 may be a battery or other alternative energy sources. Again, the above are given as examples and should not be seen as to limit the scope of the present invention.

The face plate 102 will have a pair of clock hands 130 rotatably coupled thereto. The clock hands 130 will rotate around the front surface of the face plate 102 in order to display the time of day. The clock hands 130 are coupled to a clock control device 132. The clock control device 132 is used to control the rotation of the clock hands 130 around the face plate 102. As shown in FIG. 3, the clock control device 132 is generally attached to the rear surface of the face plate 102 so that the clock control device 132 is not visible. However, the clock control device 132 may be attached to other surfaces of the EL clock 100 without departing from the spirit and scope of the present invention.

The clock control device 132 is powered by power supply 134. The power supply 134 may be an AC power supply, a DC power supply like a battery, or any other type of alternative power source. In the embodiment depicted in FIG. 3, the power supply 134 is a battery. However, this is only shown as an example and should not be seen as to limit the scope of the present invention.

The EL clock 100 may have a cover 126. The cover 126 would be attached to and cover 126 the face plate 102. The cover 126 is used to protect the EL panel 106 from damage due to the elements or from people touching the EL panel 106. The cover 126 is generally a clear/translucent cover. The cover 126 may be formed of a light weight but sturdy material such as plastic, acrylic, or the like. The listing of the above is given as an example and should not be seen as to limit the scope of the present invention.

The EL clock 100 may further have a mounting device 128. The mounting device 128 is used to mount the EL clock 100 to a wall or other object. The mounting device 128 is generally attached to the back surface of the face plate 102.

In operation, the clock control device 122 will continuously operate so that the EL clock 100 will accurately keep the time of day. The EL panel 106 will illuminate in one of two manners. If the is no activation device 122, then the EL panel 106 will be continuously illuminated. Thus, the different colors/sections will illuminate and then fade off based on the how the controller 120 is programmed. If an activation device 122 is used, then the EL panel 106 will be illuminated only when the activation device 122 is tripped. For example, the activation device 122 may be tripped when the activation device 122 senses movement, heat of an individual's body, noise of a certain decibel level, and the like. Once activated, the different colors/sections of the EL panel 106 will illuminate and then fade off based on the how the controller 120 is programmed. For example, the controller may have a timer unit which allows the EL panel 106 to illuminate for five minutes and then deactivate until the activation device 122 is tripped again.

While embodiments of the disclosure have been described in terms of various specific embodiments, those skilled in the art will recognize that the embodiments of the disclosure can be practiced with modifications within the spirit and scope of the claims.

What is claimed is:

1. An electroluminescent (EL) clock comprising:
a face plate;
an electroluminescent (EL) light panel coupled to a front surface of the face plate, the EL light panel having a multi-color/sectional design;
a control circuit coupled to the EL light panel and attached to a rear surface of the face plate, the control circuit individually controlling the lighting of each color/section of the multi-color/sectional design;
a pair of clock hands rotatably coupled to the face plate;
a clock control device coupled to the pair of clock hands to rotate the pair of clock hands; and
a power supply coupled to the control circuit and the cock control device.

2. An EL clock in accordance with claim 1 further comprising a cover coupled to the face plate to protect the EL light panel from damage.

3. An EL clock in accordance with claim 1 wherein the power supply comprises:
a first power source coupled to the control circuit; and
a second power source coupled to the

4. An EL clock in accordance with claim 3 wherein the first power source comprises:
wiring coupled to the control circuit; and
a voltage regulator coupled to the wiring, the voltage regulator have a pair of connectors for attaching the voltage regulator to an outlet.

5. An EL clock in accordance with claim 3 wherein the second power source comprises a battery.

6. An EL clock in accordance with claim 1 wherein the control circuit comprises:
a plurality of pairs of conductors, wherein each pair of conductors is coupled to an individual color/section of the multi-color/sectional design; and
a controller coupled to each of the plurality of pairs of conductors.

7. An EL clock in accordance with claim 6 wherein the control circuit further comprising an activation device coupled to the face plate and the control circuit to activate and deactivate the EL light panel.

8. An EL clock in accordance with claim 7 wherein the activation device is one of: motion sensor, sound sensor, heat sensor, and combinations thereof.

9. An EL clock in accordance with claim 1 further comprising a mounting device coupled to the rear surface of the face plate for mounting the EL clock.

10. An electroluminescent (EL) clock comprising:
a face plate;
an electroluminescent (EL) light panel coupled to a front surface of the face plate, the EL light panel having a multi-color/sectional design;
a control circuit coupled to the EL light panel and attached to a rear surface of the face plate, the control circuit individually controlling the lighting of each color/section of the multi-color/sectional design;
a pair of clock hands rotatably coupled to the face plate;
a clock control device coupled to the pair of clock hands to rotate the pair of clock hands;
a power supply coupled to the control circuit and the cock control device;
a cover coupled to the face plate to protect the EL light panel from damage; and
an activation device coupled to the control circuit to control activation and deactivation of the EL light panel.

11. An EL clock in accordance with claim 10 wherein the power supply comprises:
a first power source coupled to the control circuit; and
a second power source coupled to the

12. An EL clock in accordance with claim 11 wherein the first power source comprises:
wiring coupled to the control circuit; and
a voltage regulator coupled to the wiring, the voltage regulator have a pair of connectors for attaching the voltage regulator to an outlet.

13. An EL clock in accordance with claim 11 wherein the second power source comprises a battery.

14. An EL clock in accordance with claim 10 wherein the control circuit comprises:
a plurality of pairs of conductors, wherein each pair of conductors is coupled to an individual color/section of the multi-color/sectional design; and
a controller coupled to each of the plurality of pairs of conductors.

15. An EL clock in accordance with claim 10 wherein the activation device is one of: motion sensor, sound sensor, heat sensor, and combinations thereof.

16. A method of forming an electroluminescent (EL) clock comprising:
providing a face plate;
attaching an electroluminescent (EL) light panel to a front surface of the face plate, the EL light panel having a multi-color/sectional design;
attaching a control circuit to the EL light panel and to a rear surface of the face plate, the control circuit individually controlling the lighting of each color/section of the multi-color/sectional design;
attaching a clock control device and a pair of clock hands to the face plate so the pair of clock hands rotate around the face plate; and
attaching a power supply to the control circuit and the cock control device.

17. The method of claim 16 further comprising attaching a cover to the face plate to protect the EL light panel from damage.

18. The method of claim 16 wherein attaching a control circuit further comprises:
providing a plurality of pairs of conductors, wherein each pair of conductors is coupled to an individual color/section of the multi-color/sectional design; and
providing a controller coupled to each of the plurality of pairs of conductors.

19. The method of claim 16 further comprising attaching an activation device to the face plate and the control circuit to activate and deactivate the EL light panel.

20. The method of claim 16 further comprising attaching a mounting device to the rear surface of the face plate for mounting the EL clock.
